(19) United States
(12) Patent Application Publication
(10) Pub. No.: US 2016/0116093 A1
(43) Pub. Date: Apr. 28, 2016

(54) HOSE END FITTING SYSTEM FOR POLYETRAFLUOROETHYLENE (PTFE)-CORE HOSE

(71) Applicant: Larry Filipczak, West Bloomfield, MI (US)

(72) Inventor: Larry Filipczak, West Bloomfield, MI (US)

(21) Appl. No.: 14/925,632

(22) Filed: Oct. 28, 2015

Related U.S. Application Data
(60) Provisional application No. 62/069,396, filed on Oct. 28, 2014.

(51) Int. Cl. F16L 33/22; F02M 55/02; F16L 21/08; F16L 33/18; F16L 15/04; F16L 15/08

(52) U.S. Cl. CPC F16L 33/22; F16L 15/04; F16L 15/08; F16L 21/08; F16L 33/18; F02M 55/02

(57) ABSTRACT

A hose end fitting apparatus for coupling a PTFE core hose to a rigid fluid carrying tube. The fluid fitting includes a connector including a one piece body having a first and carrying threads for connection to an A-N connector mounted on one end of a PTFE hose. A second end of the body is engageable with a rigid tube.

### CROSS REFERENCE TO CO-PENDING APPLICATIONS

This application claims priority benefit to the Oct. 28, 2014 filing date of co-pending U.S. Provisional Patent Application Ser. No. 62/069,396 for a HOSE END FITTING SYSTEM FOR POLYTETRAFLUOROETHYLENE (PTFE)-CORE HOSE, the entire contents of which are incorporated herein in its entirety.

### BACKGROUND

The present disclosure relates to the field of liquid transfer hose assemblies, and in particular to a new design of hose end fitting that installs on PolyTetraFluoroEthylene, or PTFE-core hose, for use in combustible liquid fuel transfer systems (example: liquid fuel transfer systems used on internal combustion engine-propelled vehicles) that is secured on the hose with a worm gear or band clamp.

There remains a problem in the prior art in that today's automotive fuel has become incompatible with commonly used hose assemblies consisting of black rubber fuel hose and existing barb fitting technology. Today's fuel degrades the rubber hose itself and/or results in fuel vapor constantly seeping through the rubber hose carcass. This results in a constant ‘fuel smell’ in many vehicles, and often is the precursor to catastrophic failure of the rubber hose after only a short time exposure to the fuel, which produces a dangerous liquid fuel leak.

The recent prior art solution to this problem is to use hose assemblies created from PTFE-core hose and fittings as shown in FIGS. 6 and 7. The prior art liquid fuel system fittings for PTFE-core hose are designed for late model, fuel injection systems. These prior art high-pressure PTFE fittings are expensive, often require special knowledge and tools to properly install on PTFE-core hose and often require special adapter fittings on the vehicles to complete the installation.

These and further problems with the prior art are that current PTFE fittings were not designed to install where rubber hose and fittings were originally used—thus requiring a stack of multiple adapter fittings be used in combination to end up with the proper attachment threads and sizing.

### SUMMARY

The present fitting system uniquely enables PTFE fittings to be used to install a PTFE hose to a rigid tube where rubber hoses and fittings were originally used thereby eliminates the need for multiple adapter fittings in combination to end up with the proper attachment threads and sizing. The present fitting system uses standard compression nut connectors and ferrules along with a one piece connector body for simplified connection of the PTFE hose to a rigid fluid carrying tube.

In one aspect, a fluid fitting includes a one piece connector including a body having a first end carrying threads for connection to an A-N connector mounted on one end of a flexible polytetrafluoroethylene hose; and a second end carrying external threads engageable with a rigid tube connector to sealingly connect a rigid tube to the body.

In one aspect, the first end of the body is tubular first end to be disposed in fluid flow communication within the polytetrafluoroethylene hose through the A-N connector.

In one aspect, a compression nut disposed over the tubular first end inside of the A-N connector.

In one aspect, a compression nut disposed within the second end of the body engagable with a rigid tube connector.

In one aspect, hex flats carried on the body intermediate to first and second ends.

In one aspect, a fluid fitting includes a one piece body having a first end carrying a threads for connection to an A-N connector mounted on one end of a flexible polytetrafluoroethylene hose; and a second end carrying external threads engageable with a rigid tube connector to sealingly connect a rigid tube to the body the first end of the body is tubular first end to be disposed in fluid flow communication within the polytetrafluoroethylene hose through the A-N connector. A compression nut disposed over the tubular first end inside of the A-N connector a compression nut disposed within the second end of the body engagable with a rigid tube connector hex flats carried on the body intermediate to first and second ends a flexible polytetrafluoroethylene hose with an interior tube having a first end; an A-N connector with internal threads at one end and hollow bore extending between the one end and an opposed end; a first compression nut; a one piece connector including a body having a first end carrying threads for connection to the A-N connector mounted on one end of the polytetrafluoroethylene hose; a second end carrying external threads; a second compression nut; and a ridge tube connector coupled by the compression nut to the ridged tube and one end of the body, a compression nut disposed over the tubular first end inside of the A-N connector, a compression nut disposed over the tubular first end inside of the A-N connector, a compression nut disposed within the second end of the body engageable with a rigid tube connector, hex flats carried on the body intermediate to first and second ends.

In another aspect, a fluid fitting apparatus includes a flexible polytetrafluoroethylene hose with an interior tube having a first end; an A-N connector with internal threads at one end and hollow bore extending between the one end and an opposed end; a first compression nut; a one piece connector including a body having a first end carrying threads for connection to the A-N connector mounted on one end of the polytetrafluoroethylene hose; a second end carrying external threads; a second compression nut; and a ridge tube connector coupled by the compression nut to the ridged tube and one end of the body.

In one aspect, the first end of the body is tubular first end to be disposed in fluid flow communication within the polytetrafluoroethylene hose through the A-N connector.

In one aspect, hex flats carried on the body intermediate to first and second ends.

### BRIEF DESCRIPTION OF THE DRAWINGS

Additional advantages and novel features of the system will be set forth in part in the description that follows, and in part will become more apparent to those skilled in the art upon examination of the following drawings in which:

FIG. 1 is exploded side elevational view of a hose end fitting system for a PTFE core hose to a rigid tube;

FIG. 2 is an enlarged, exploded, perspective view of an initial assembly steps for the hose and fitting shown in FIG. 1;

FIG. 3 is a side elevational view of another aspect of the hose end fitting;

FIG. 4 is a cross sectional view of a portion of the assembled hose end fitting shown in FIG. 3;

FIG. 5 is a side elevational view of the assembled hose end fitting shown in FIG. 1;

FIG. 6 is an exploded perspective view of a prior art PTFE hose end fitting; and

FIG. 7 is a side elevational view showing the assembly of the hose end fitting to the PTFE hose depicted in FIG. 6.

### DETAILED DESCRIPTION

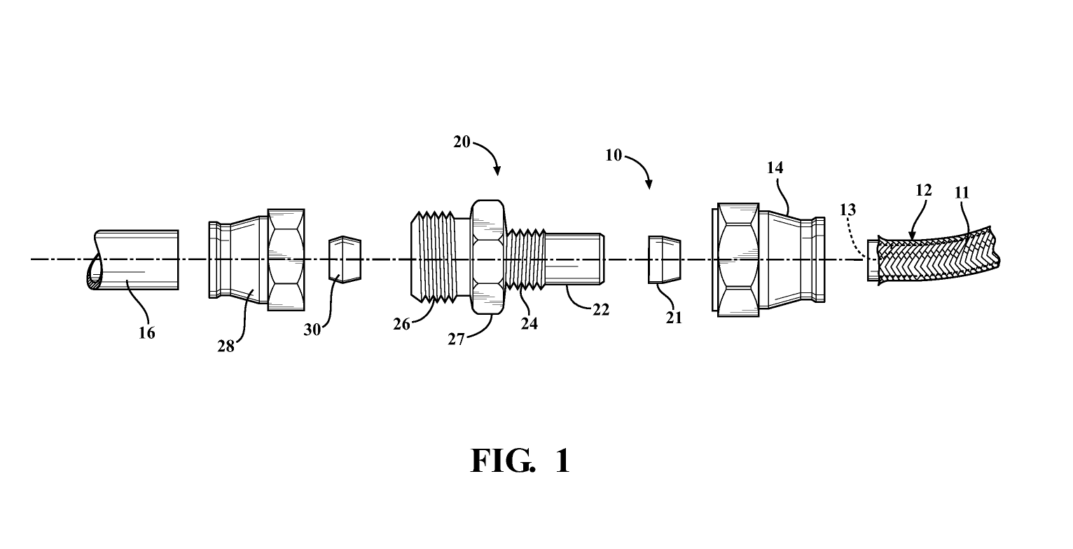

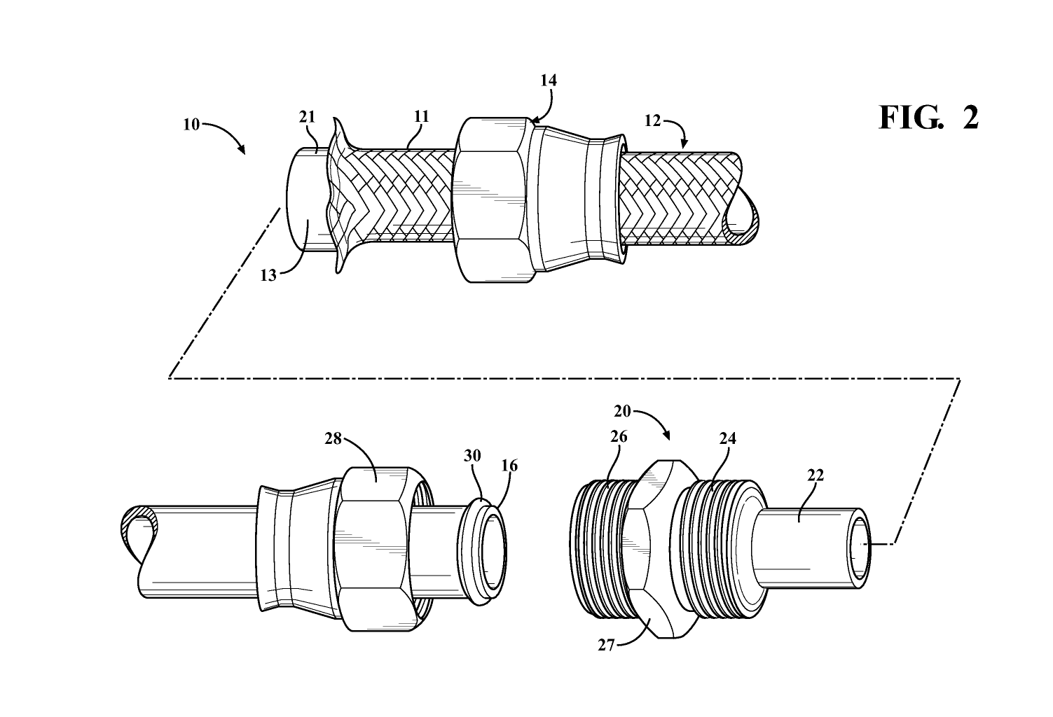

Referring now to FIGS. 1-5, there is depicted aspects of a hose end fitting system 10 which is used to connect a flexible polytetrafuoroethylene (PTFE) hose 12 through an A-N connector 14 directly to a hard or rigid tube 16. The rigid tube 16 has substantial imcompressability due to a rigid outer wall but may be flexible if provided in a thin thickness and a long length. The rigid tube 16 can be formed of any suitable material, such as steel, stainless steel, aluminum, plastic, multilayer materials, etc.

The fitting system 10 provides the connection between the PTFE hose 12 and the rigid tube 16 in a one piece, reusable connector, rather than the multiple pieces that were previously required.

The fitting system 10 includes a connector 20 in the form of a one piece body having a first tubular end 22 which is sized to fit within a crimp member, such as a compression nut or ferrule 21, and inserted into the open end of the PTFE hose 12 through the A-N connector 14. The PTFE hose 12 is depicted, by example, in FIGS. 1-5 as including a flexible inner hollow tube 13 surrounded by an outer covering, such as a braided steel sleeve.

A first external threaded portion 24 on the connector 20 threadingly connects to the internal threads in the A-N connector 14 to attach the connector 20 to the PTFE hose 12. The connector 20 also includes an intermediate hex flats portion 27 to facilitate handling.

A second threaded portion 26 at a second end of the connector 20 is sized to engage a compression nut connector 28 through which the rigid tube 16 extends. Another crimp element, such as a compression nut or ferrule 30, fits over the end of the rigid tube 16 to enable the connector 28 to threadingly and sealingly connect the rigid tube 16 to the second threaded portion 26 of the connector 20.

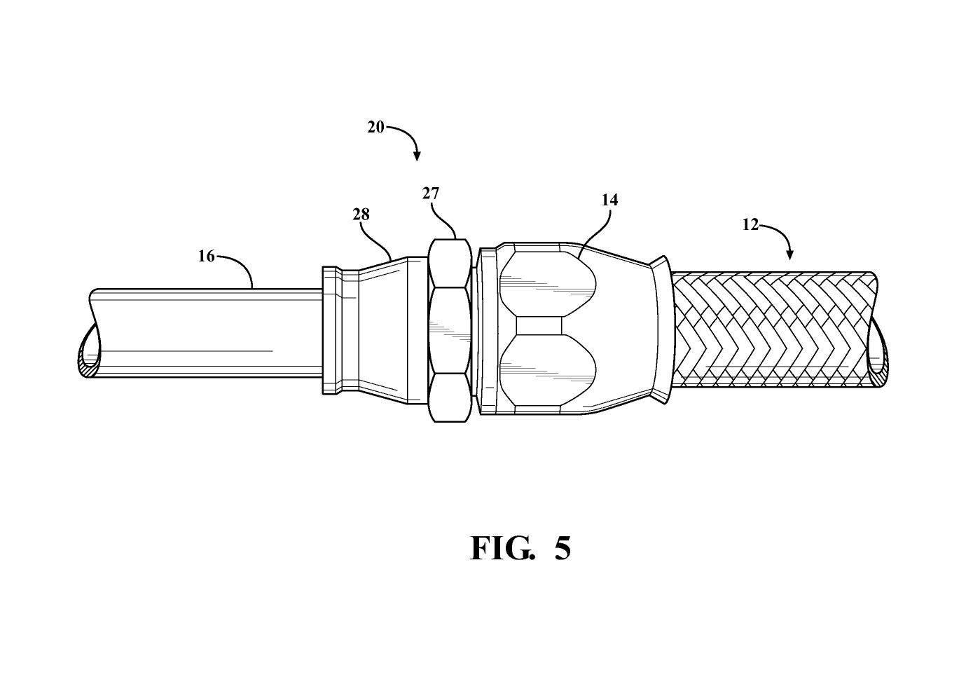

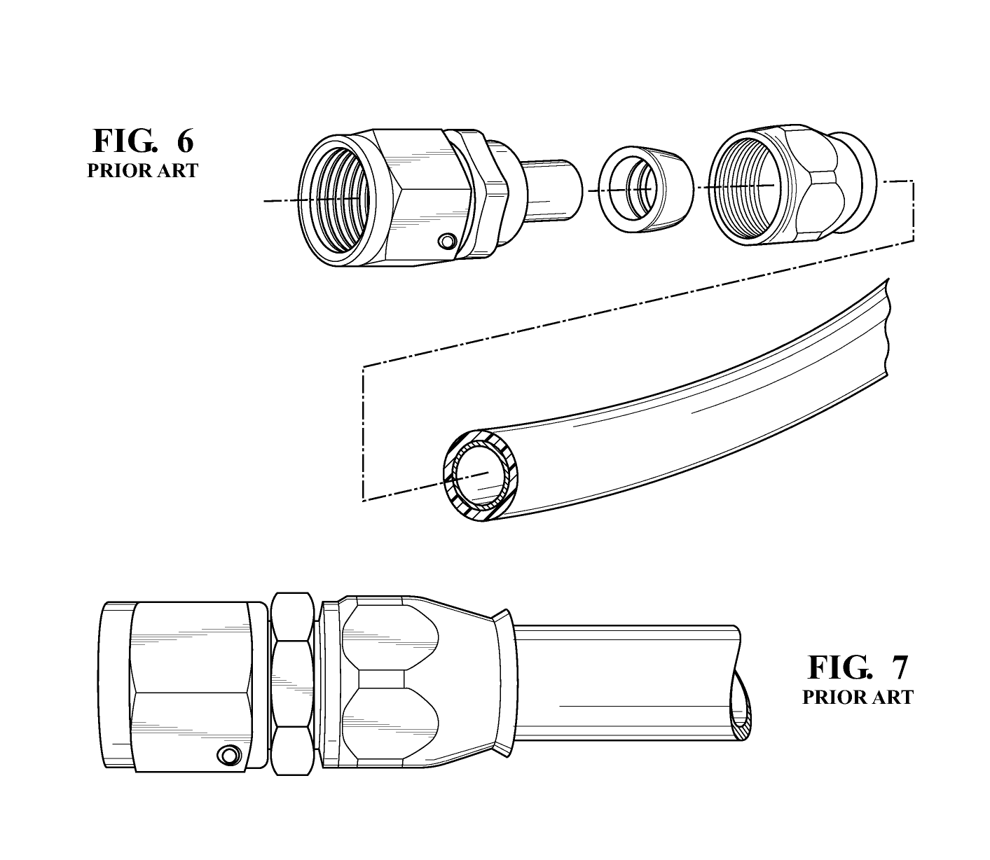

The connector 20 has a hollow through bore extending from opposed ends to enable fluid flow from the PTFE hose 12 to the rigid tube 16 when the fitting assembly 10 is in its assembled state as shown in FIG. 5.

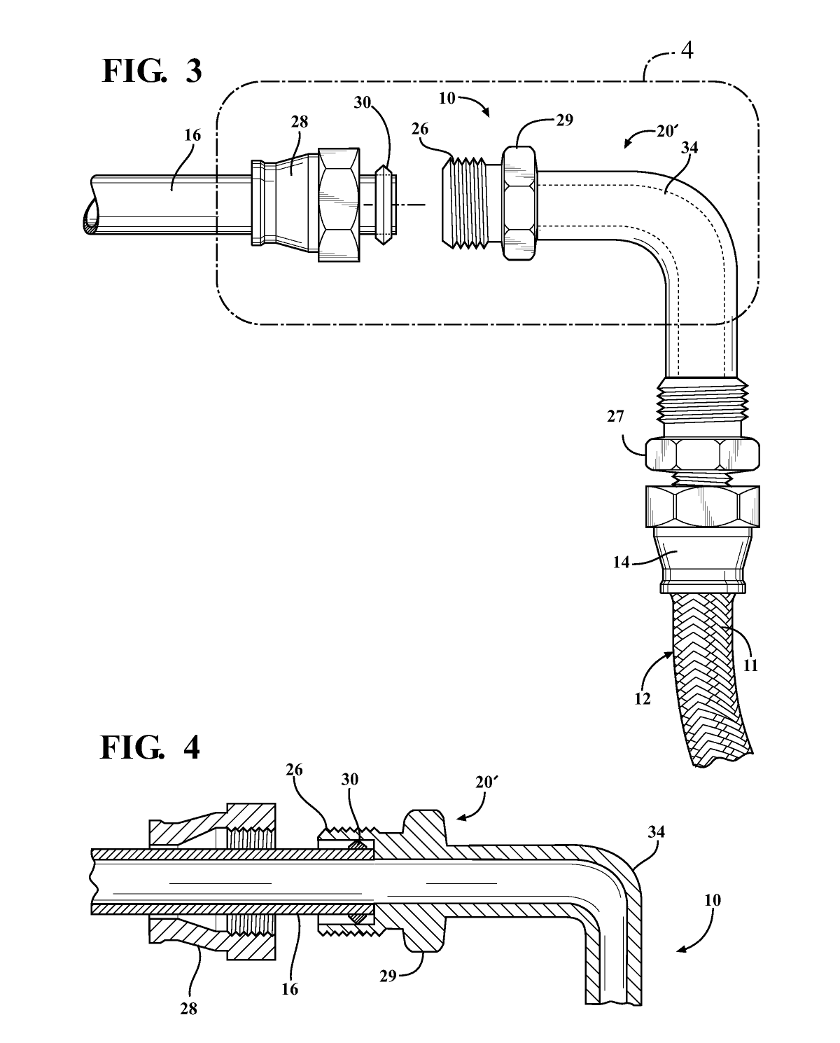

The connector 20 can be constructed in a straight line version as shown in FIGS. 1, 2 and 5 as well as in various angular configurations, such as 30°, 45° or the 90° angled construction shown by example in FIGS. 3 and 4.

In Fig. , the angled connector 40 includes the tubular end portion 22 inserted into the end of the PTFE hose 12, the outer hex flats portion 27 and the second threaded end portion 26.

The connector 40 includes a second hex flats portion 29 located adjacent to the second threaded portion 26 as well as an intermediate angled tubular portion 34 which disposes the opposed ends of the connector 40 at an angle.

What is claimed is:

1. A fluid fitting comprising:
a one piece connector including a body having a first end carrying threads for connection to an A-N connector mounted on one end of a flexible polytetrafluoroethylene hose; and
a second end carrying external threads engageable with a rigid tube connector to sealingly connect a rigid tube to the body.

2. The fluid fitting of claim 1 wherein:
the first end of the body is tubular first end to be disposed in fluid flow communication within the polytetrafluoroethylene hose through the A-N connector.

3. The fluid fitting of claim 2 further comprising:
a compression nut disposed over the tubular first end inside of the A-N connector.

4. The fluid fitting of claim 1 comprising:
a compression nut disposed within the second end of the body engagable with a rigid tube connector.

5. The fluid fitting of claim 1 further comprising:
hex flats carried on the body intermediate to first and second ends.

6. A fluid fitting comprising:
a one piece body having a first end carrying a threads for connection to an A-N connector mounted on one end of a flexible polytetrafluoroethylene hose;
a second end carrying external threads engageable with a rigid tube connector to sealingly connect a rigid tube to the body;
the first end of the body being a tubular first end to be disposed in fluid flow communication within the polytetrafluoroethylene hose through the A-N connector;
first a compression nut disposed over the tubular first end inside of the A-N connector; and
a second compression nut disposed within the second end of the body engagable with a rigid tube connector.

7. The fluid fitting of claim 6 further comprising:
hex flats carried on the body intermediate to first and second ends.

8. A fluid fitting apparatus comprising:
a flexible polytetrafluoroethylene hose with an interior tube having a first end;
an A-N connector with internal threads at one end and hollow bore extending between the one end and an opposed end;
a first compression nut;
a one piece connector including a body having a first end carrying threads for connection to the A-N connector mounted on one end of the polytetrafluoroethylene hose;
a second end carrying external threads;
a second compression nut; and
a ridge tube connector coupled by the compression nut to the ridged tube and one end of the body.

9. The fluid fitting apparatus of claim 8 wherein:
the first end of the body is tubular first end to be disposed in fluid flow communication within the tube of the polytetrafluoroethylene hose through the A-N connector.

10. The fluid fitting apparatus of claim 8 further comprising:
hex flats carried on the body intermediate to first and second ends.
